(19) United States
(12) Patent Application Publication
(10) Pub. No.: US 2025/0130169 A1
(43) Pub. Date: Apr. 24, 2025

(54) SCANNING MICROSCOPE, METHOD FOR PROCESSING DATA, AND STORAGE MEDIUM

(71) Applicant: Evident Corporation, Tatsuno-machi (JP)

(72) Inventor: Chika NAKAMOTO, Kamiina-gun (JP)

(73) Assignee: Evident Corporation, Tatsuno-machi (JP)

(21) Appl. No.: 18/911,808

(22) Filed: Oct. 10, 2024

(30) Foreign Application Priority Data
Oct. 20, 2023 (JP) 2023-180974

(51) Int. Cl. G01N 21/64; G02B 21/00; H04N 25/40; H04N 25/76; H04N 25/78

(52) U.S. Cl. CPC G01N 21/6458; G02B 21/0032; G02B 21/0036; G02B 21/0076; G02B 21/008; H04N 25/40; H04N 25/7795; H04N 25/78

(57) ABSTRACT

There is provided a scanning microscope that samples light from a sample irradiated with pulsed light and converts the light into data for each pixel, in which a sampling time per pixel is substantially an integer multiple of a pulse period of the pulsed light, and a sampling start timing of each pixel is synchronized with a pixel synchronization signal.

### Cross Reference to Related Applications

This application is based upon and claims the benefit of priority of the prior Japanese Patent Application No. 2023-180974, filed Oct. 20, 2023, the entire contents of which are incorporated herein by reference.

### BACKGROUND OF THE INVENTION

### Field of the Invention

The present disclosure relates to a scanning microscope, a method for processing data, and a storage medium.

Description of the Related Art

In the related art, a microscope that samples fluorescence in synchronization with an emission timing of laser light which is periodically emitted from a light source such as a pulsed laser is known (see, for example, JP 2001-159734 A). According to this microscope, a fluorescence signal including a peak can be reliably sampled.

### SUMMARY OF THE INVENTION

According to one aspect of the invention, there is provided a scanning microscope that samples light from a sample irradiated with pulsed light and converts the light into data for each pixel, in which a sampling time per pixel is substantially an integer multiple of a pulse period of the pulsed light, and a sampling start timing of each pixel is synchronized with a pixel synchronization signal.

According to another aspect of the invention, there is provided a scanning microscope including: a laser light source that emits pulsed light; a scanner that two-dimensionally scans the pulsed light on a sample; a photodetector that detects light from the sample; and a processor that generates pixel data of each of pixels forming an image of the sample based on an output signal from the photodetector and a pixel synchronization signal synchronized with a scanning position of the scanner, sets a sampling time per pixel to be substantially an integer multiple of a pulse period of the pulsed light, and synchronizes a sampling start timing of each pixel with the pixel synchronization signal.

According to still another aspect of the invention, there is provided a method for processing data for causing a computer to execute processing of sampling light from a sample irradiated with pulsed light and converting the light into data for each pixel, in which a sampling time per pixel is substantially an integer multiple of a pulse period of the pulsed light, and a sampling start timing of each pixel is synchronized with a pixel synchronization signal.

According to still another aspect of the invention, there is provided a computer-readable storage medium storing a program for causing a computer to execute processing of sampling light from a sample irradiated with pulsed light and converting the light into data for each pixel, in which a sampling time per pixel is substantially an integer multiple of a pulse period of the pulsed light, and a sampling start timing of each pixel is synchronized with a pixel synchronization signal.

### BRIEF DESCRIPTION OF THE DRAWINGS

FIG. 1 is a diagram illustrating a configuration of a scanning microscope according to an embodiment;

FIG. 2 is a timing chart illustrating pulsed laser light, excited fluorescence, and each signal;

FIG. 3 is a timing chart illustrating individual signals in a case where a scanner is a resonant scanner;

FIG. 4 is a timing chart illustrating pulsed laser light and excited fluorescence; and

FIG. 5 is a diagram illustrating a hardware configuration of a computer.

### DESCRIPTION OF THE EMBODIMENTS

Even in a case where fluorescence is sampled in synchronization with an emission timing of laser light, a sampling time per pixel forming an image varies depending on observation conditions (for example, an observation range, a scanning speed, and the resolution of the image) and the like, and an emission cycle of the laser light depends on a light source. Hence, it is difficult to sample a pixel in synchronization with the emission cycle of the laser light, and the number of times of emission of the laser light differs for each pixel. As a result, even when a fluorescence body is homogeneous and uniform, the brightness varies for each pixel, and this causes a problem in that brightness unevenness occurs in a generated image. In particular, the shorter the sampling time per pixel, the more significant this problem becomes.

Performance enhancement of the laser scanning microscope is supported by high resolution and high speed (high frame rate). These are supported by reduction in the sampling time per pixel. On the other hand, an emission cycle of laser light from an ultrashort pulse laser used for multiphoton excitation observation is determined by the ultrashort pulse laser and is difficult to randomly change. Therefore, when the sampling time per pixel is shortened and the number of times of emission of the laser light per pixel decreases, a difference of only one in the number of times of emission of the laser light per pixel results in a large change in brightness. Since both the emission of the laser light and the sampling of the pixel are repeated at certain frequencies, a beat of a difference frequency thereof is produced in a generated image, and brightness unevenness (for example, stripe noise) that hinders observation can occur.

Embodiments of the invention will be described below with reference to the drawings.

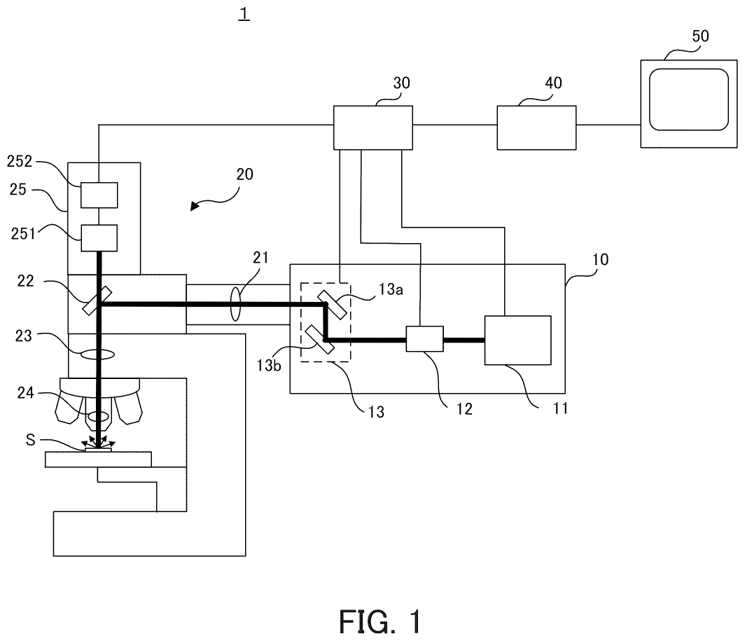

FIG. 1 is a diagram illustrating a configuration of a scanning microscope according to an embodiment.

A scanning microscope 1 illustrated in FIG. 1 includes a laser light source device 10, a microscope body 20, and a control device 30.

The laser light source device 10 includes a laser light source 11, a light control unit 12, and a scanner 13.

The laser light source 11 emits pulsed laser light (pulsed light). Specifically, the laser light source 11 emits laser light having an intensity which changes to have a peak at a predetermined cycle. In addition, the laser light source 11 outputs a laser pulse signal synchronized with the emission of the laser light to the control device 30. The laser light source 11 is a pulse-oscillated laser such as a pulsed titanium sapphire (TiSa) laser, a high-frequency-superimposed laser diode (LD), or the like.

The light control unit 12 adjusts the intensity of the laser light emitted from the laser light source 11 in accordance with an instruction from the control device 30. The light control unit 12 is an acousto-optic element, a shutter, a neutral density filter, or the like. Note that the intensity of the laser light may be adjusted by controlling a driving current of the laser light source 11 by the control device 30. In this case, the light control unit 12 can be omitted.

The scanner 13 scans laser light having intensity adjusted by the light control unit 12. The scanner 13 includes, for example, a pair of galvano mirrors 13a and 13b coated with aluminum and is driven by a raster scan method by changing angles of the galvano mirrors 13a and 13b in accordance with an instruction from the control device 30. Consequently, the laser light from the laser light source 11 can be two-dimensionally scanned on a sample (a specimen or a sample) S. The scanner 13 may be such a galvano scanner, a resonance scanner such as a resonant scanner, an acousto-optic deflection element, or the like.

The microscope body 20 includes a lens 21, a dichroic mirror 22, a lens 23, an objective lens 24, and a photodetector 25.

The lenses 21 and 23 relay the laser light from the laser light source device 10 to the objective lens 24. The objective lens 24 irradiates the sample S with the laser light and condenses light from the sample S. The light from the sample S is, for example, fluorescence generated in the sample S by being excited due to irradiation of the sample S with the laser light.

The dichroic mirror 22 reflects the laser light from the laser light source device 10 toward the objective lens 24 and transmits the light from the sample S condensed by the objective lens 24, thereby causing an optical path of the laser light and an optical path of the light from the sample S to branch from each other.

The photodetector 25 detects the light from the sample S transmitted through the dichroic mirror 22. Specifically, the photodetector 25 includes a photoelectric conversion element 251 and a photodetection circuit 252. The photoelectric conversion element 251 photoelectrically converts the light from the sample S transmitted through the dichroic mirror 22 and outputs an electric signal corresponding to the brightness of the light. The photoelectric conversion element 251 is a photo multiplier tube (PMT), a multi-pixel photon counter (MPPC), or the like. The photodetection circuit 252 performs A/D conversion on an output signal of the photoelectric conversion element 251 in synchronization with a sampling clock and outputs a converted signal. Note that it is assumed that periods of the sampling clocks are equal intervals.

The control device 30 controls the laser light source device 10 and the microscope body 20. In addition, as will be described below in detail, the control device 30 generates pixel data (brightness data) of each pixel forming an image of the sample S from the output signal of the photodetector 25 (the output signal of the photodetection circuit 252).

A personal computer (PC) 40 to which a monitor 50 such as a liquid crystal display is connected is connected to the control device 30. The PC 40 generates image data of the sample S on the basis of the pixel data of each pixel generated by the control device 30 and an image synchronization signal such as a horizontal synchronization signal or a vertical synchronization signal generated on the basis of the movement of the scanner 13 that determines a scanning position on the sample S, and the PC causes an image of the sample S related to the generated image data to be displayed on the monitor 50.

Hereinafter, processing in which the control device 30 generates pixel data of each pixel from the output signal of the photodetector 25 will be described in more detail.

The control device 30 receives, for example, a scanning condition such as a scanning speed or resolution of the scanner 13 from the PC 40, calculates a pixel period indicating a cycle of one pixel on the basis of the received scanning condition, and generates a pixel synchronization signal for determining start and end timings of the calculated pixel period. Note that the pixel period corresponds to a time during which the scanning position of the laser light on the sample S by the scanner 13 remains at a position corresponding to one pixel.

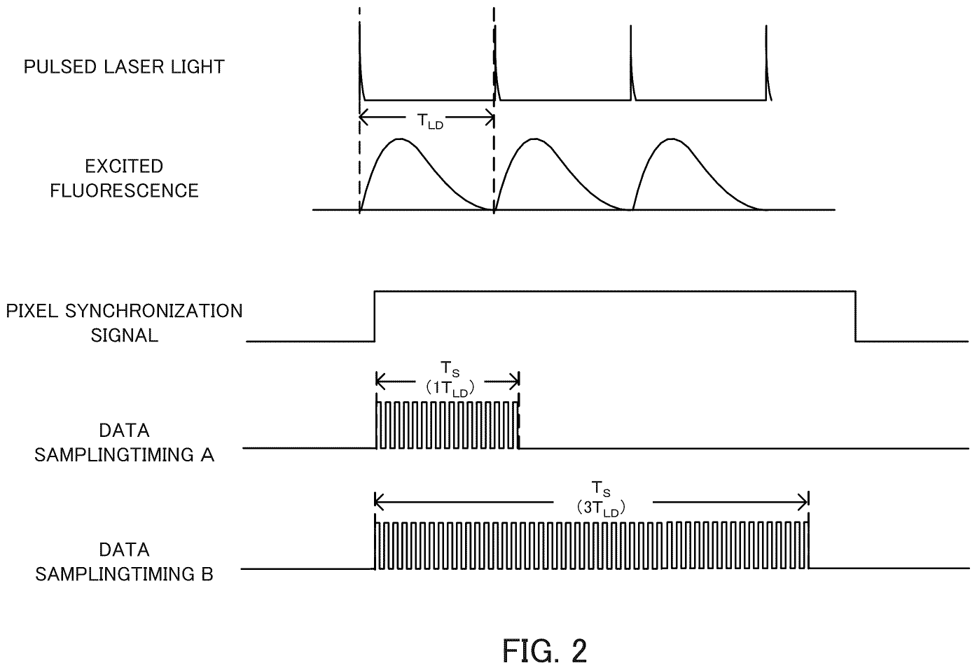

As will be described below in detail with reference to FIG. 2, the control device 30 sets the sampling time per pixel to an integer multiple (positive integer multiple) of a pulse period of the pulsed laser light emitted from the laser light source 11, synchronizes a sampling start timing of each pixel with the pixel synchronization signal, and generates pixel data of each pixel from the output signal of the photodetector 25. However, the sampling time per pixel is a time equal to or shorter than the pixel period (a period of the pixel synchronization signal).

FIG. 2 is a timing chart illustrating pulsed laser light, excited fluorescence, and each signal. The pulsed laser light emitted from the laser light source 11, the fluorescence excited in the sample S (light from the sample S), the pixel synchronization signal, a data sampling timing A, and a data sampling timing B are illustrated in order from the top.

The data sampling timing A indicates a sampling clock at a sampling time (T_{S}) of each pixel in a case where the sampling time (T_{S}) per pixel is a time (1T_{LD}) that is one time a pulse period (T_{LD}) of the pulsed laser light (however, FIG. 2 illustrates only a sampling clock at the sampling time (T_{S}) of one pixel). The data sampling timing B indicates a sampling clock at the sampling time (T_{S}) of each pixel in a case where the sampling time (T_{S}) per pixel is a time (3T_{LD}) that is three times the pulse period (T_{LD}) of the pulsed laser light (however, FIG. 2 illustrates only a sampling clock at the sampling time (T_{S}) of one pixel). At any of the data sampling timings, the sampling start timing of each pixel (the start timing of the sampling time (T_{S})) is synchronized with the pixel synchronization signal (specifically, a rise of the pixel synchronization signal). Hence, the sampling start timing of each pixel is determined on the basis of only the pixel synchronization signal without considering an emission timing of the pulsed laser light and the like. Note that the sampling clock is a sampling clock of the A/D conversion performed by the photodetection circuit 252, and a period thereof is sufficiently short to such an extent that, for example, a peak of fluorescence generated in the sampling time (T_{S}) is not missed (sampling is not impaired). In the sampling time (T_{S}) of each pixel, the control device 30 captures and accumulates (or averages or the like) the signals A/D-converted by the photodetection circuit 252, thereby generating pixel data of each pixel.

For example, it is assumed that the laser light source 11 is an ultrashort pulse laser that emits ultrashort-pulsed laser light of 80 MHz, and the pixel period is 100 ns. In this case, since the pulse period (T_{LD}) of the ultrashort-pulsed laser light is 12.5 ns, the optimum sampling time (T_{S}) per pixel is 100 ns that is eight times the pulse period (T_{LD}) of the ultrashort-pulsed laser light. Note that the sampling time (T_{S}) per pixel may be an integer multiple of the pulse period (T_{LD}) of the ultrashort-pulsed laser light, and is desirably longer in order to obtain higher brightness. Therefore, here, the optimum sampling time (T_{S}) per pixel is set to eight times the pulse period (T_{LD}) of the ultrashort-pulsed laser light, which is equal to 100 ns of the pixel period. The optimum sampling time (T_{S}) per pixel is, for example, a time obtained by multiplying the pulse period (T_{LD}) of the ultrashort-pulsed laser light by N, where N represents an integer part of a result obtained by dividing the pixel period by the pulse period (T_{LD}) of the ultrashort-pulsed laser light.

In this case, for example, when a frequency of the sampling clock is 960 MHz, the sampling per pixel is performed 96 times. Hence, in this case, the sampling (A/D conversion) is performed 96 times in the sampling time (T_{S}) of each pixel. In this manner, the number of times of sampling at the sampling time (T_{S}) of each pixel is determined by the sampling time (T_{S}) per pixel and the frequency of the sampling clock.

Note that 960 MHz, which is the frequency of the sampling clock in this case, may be obtained by, for example, making a primary oscillation period of the sampling clock equal to the pulse cycle (12.5 ns) of the ultrashort-pulsed laser light and multiplying the frequency (80 MHz) of primary oscillation by 12. Alternatively, the primary oscillation period of the sampling clock may be an integer multiple of (for example, 2 times) the pulse period (12.5 ns) of the ultrashort-pulsed laser light, and the frequency (for example, 40 MHz) of the primary oscillation may be multiplied (for example, multiplied by 24).

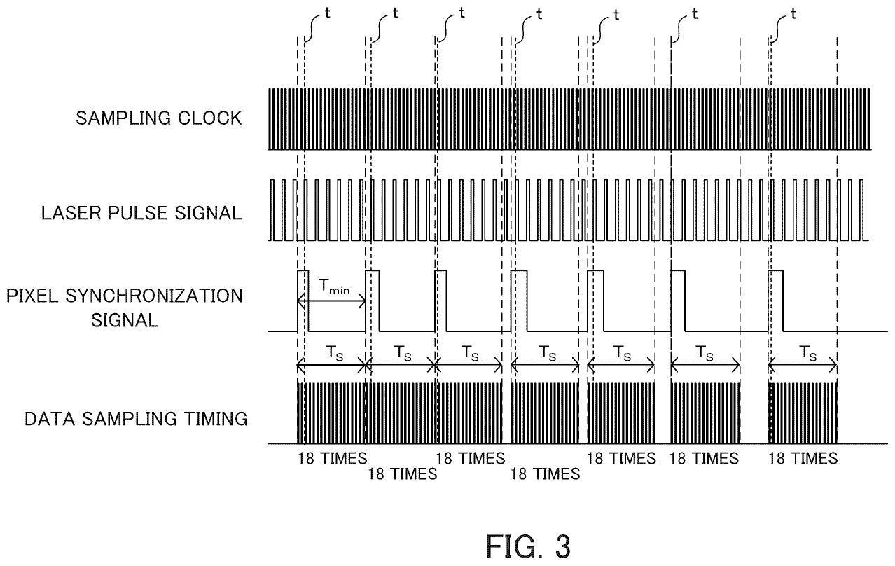

FIG. 3 is a timing chart illustrating individual signals in a case where a scanner is a resonant scanner. A sampling clock of the A/D conversion performed by the photodetection circuit 252, a laser pulse signal, a pixel synchronization signal, and a data sampling timing are illustrated in order from the top.

As illustrated in FIG. 3, in the case where the scanner 13 is the resonant scanner, periods of pixel synchronization signals are unequal intervals, and thus the sampling time (T_{S}) per pixel is a time equal to or shorter than a minimum period (Tₘᵢₙ) of the pixel synchronization signal. However, also in this case, the sampling time (T_{S}) per pixel is set to an integer multiple of the pulse period of the pulsed laser light (the pulse period of the laser pulse signal), and the sampling start timing (the start timing of the sampling time (T_{S})) of each pixel is also synchronized with the pixel synchronization signal. In the timing chart illustrated in FIG. 3, the optimum sampling time (T_{S}) per pixel is set to six times the pulse period of the pulsed laser light and is set to be equal to the time of the minimum period (Tₘᵢₙ) of the pixel synchronization signal. In addition, the frequency of the sampling clock is set to three times the frequency of the pulsed laser light, and thus, the number of times of sampling per pixel (the number of times of A/D conversion) is 18 times. Hence, the sampling (A/D conversion) is performed 18 times in the sampling time (T_{S}) of each pixel.

Note that the timing t illustrated in FIG. 3 indicates a timing at which a laser pulse signal (specifically, a rise of the laser pulse signal) is first detected in the sampling time (T_{S}) of each pixel. In this manner, the sampling start timing of each pixel is independent of the laser pulse signal.

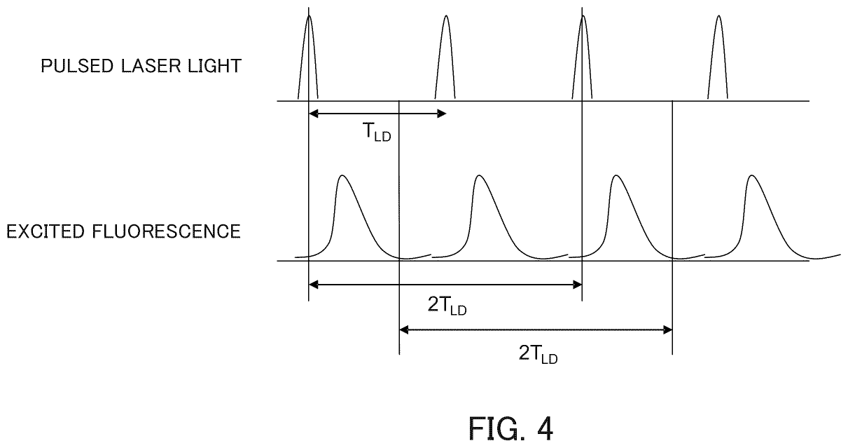

As described above, the sampling time per pixel may be an integer multiple of the pulse period of the pulsed laser light. This will be further described with reference to FIG. 4. FIG. 4 is a timing chart illustrating pulsed laser light and excited fluorescence.

As illustrated in FIG. 4, the generation of the fluorescence from the sample S with respect to the irradiation of the sample S with the pulsed laser light is a periodic phenomenon. Therefore, when the sampling time per pixel is an integer multiple of (for example, 2T_{LD} that is twice) the pulse period (T_{LD}) of the pulsed laser light, accumulation values of the fluorescence generated in the sampling times are not different from each other or have a minute difference therebetween even when the sampling start timing is any timing. Hence, brightness unevenness that can occur in the generated image can be eliminated or reduced, and it is not necessary to synchronize the sampling start timing with the pulse period of the pulsed laser light. However, as described above, the period of the sampling clock needs to be a sufficiently short period (for example, a period of about 1 ns with respect to a pulsed laser light of 80 MHz) to the extent that a peak of the fluorescence generated in the sampling time is not missed, for example.

As described above, according to the embodiment, by setting the sampling time per pixel to an integer multiple of the pulse period of the pulsed laser light, the brightness unevenness that can occur in the generated image can be eliminated or reduced. This also applies to a case where the sampling time per pixel is further shortened as the resolution and the scanning speed of the scanning microscope are increased. In addition, since the sampling start timing only needs to be synchronized with the pixel synchronization signal, it is not necessary to synchronize the sampling start timing with the pulse period of the pulsed laser light, and there is no need to perform phase adjustment or the like for synchronizing the sampling start timing.

Note that, in the embodiment, the sampling time per pixel is an integer multiple of the pulse period of the pulsed laser light, and in practice, the pulse period of the pulsed laser light slightly changes depending on a surrounding environment (for example, ambient temperature) of the laser light source 11 or the like, so that the sampling time per pixel is substantially an integer multiple of the pulse period of the pulsed laser light. Specifically, since a change amount of the pulse period of the pulsed laser light is 2 ns or shorter, the actual sampling time per pixel is an integer multiple of a period obtained by adding an error of 2 ns or shorter to the pulse period of the pulsed laser light. However, even if the actual sampling time per pixel becomes such a time, a time from the irradiation with the laser light to the generation of the fluorescence in the sample S primarily varies within a range of 2 ns or shorter, and thus there is no influence on the above-described effect that the brightness unevenness that can occur in the generated image can be eliminated or reduced, and the effect can be obtained.

In the embodiment, the pixel data is generated by accumulating the sampled (A/D converted) signals in the sampling time per pixel. Instead, the pixel data may be generated by A/D converting a result obtained by integrating the output signal of the photoelectric conversion element 251 over the sampling time per pixel. In this case, the photodetection circuit 252 integrates the output signal of the photoelectric conversion element 251 over the sampling time per pixel and outputs a signal obtained by A/D converting the integration result. Then, the control device 30 uses the signal output from the photodetection circuit 252 as the pixel data. Also in this case, the sampling start timing (integration start timing) of each pixel is synchronized with the pixel synchronization signal. In this manner, the fluorescence generated in the sampling time per pixel can be sampled without omission.

In the embodiment, the sampling time per pixel is the time equal to or shorter than the pixel period. However, in the following cases, the sampling time per pixel may exceed the pixel period. For example, in a case where the pulse period of the pulsed laser light is 12 ns and the pixel period is 35 ns, the time is equal to or shorter than the pixel period, but the obtained brightness decreases when the sampling time per pixel is 24 ns, which is twice the pulse period of the pulsed laser light. On the other hand, when the sampling time per pixel is 36 ns, which is three times the pulse period of the pulsed laser light, the time exceeds the pixel period, but the obtained brightness increases. Therefore, in a case where the sampling time per pixel is slightly longer than the pixel period, the sampling time per pixel may be set to a time exceeding the pixel period in consideration of the obtained brightness. However, in this case, since it is necessary to start processing of the subsequent pixel during processing of the preceding pixel, parallel processing is performed.

In the embodiment, it is a principle that the pulse period of the pulsed laser light is equal to or shorter than the pixel period. However, in the case where the pulse period of the pulsed laser light is longer than the pixel period, pixel data may be generated as follows. Pixel data (temporary pixel data) is temporarily generated after the sampling time per pixel is set to one time the pulse period of the pulsed laser light and the sampling start timing of each pixel is synchronized with the pixel synchronization signal. The temporary pixel data is further multiplied by a ratio of the pixel period to the pulse period of the pulsed laser light (pixel period/pulse period of the pulsed laser light), and the multiplication result is set as the final pixel data. However, also in this case, since it is necessary to start the processing of the subsequent pixel during the processing of the preceding pixel, parallel processing is performed.

In the embodiment, the control device 30 may measure the pulse period of the pulsed laser light emitted from the laser light source 11 on the basis of the laser pulse signal output from the laser light source 11.

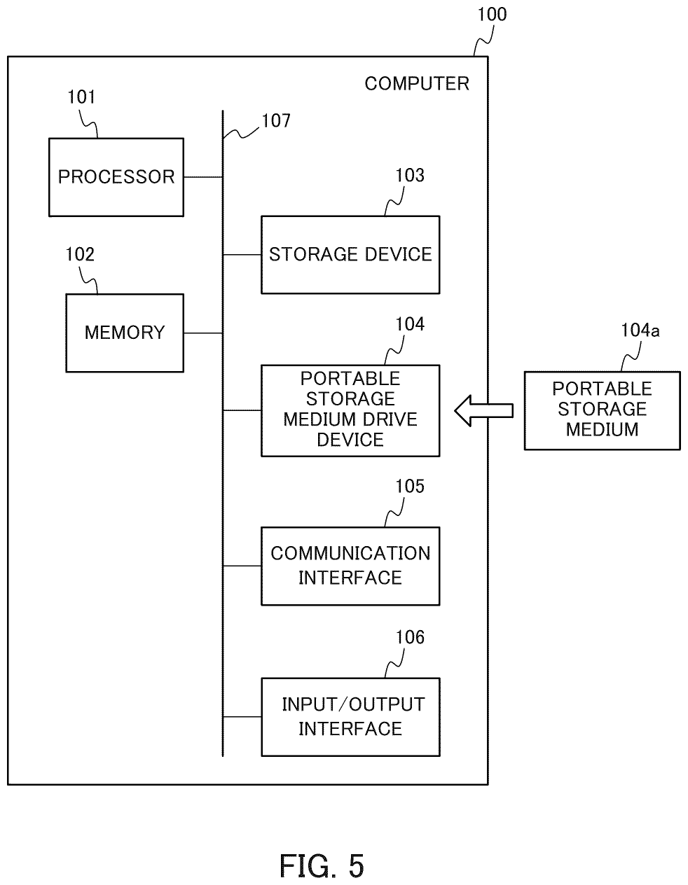

In the embodiment, the control device 30 may be realized by a computer illustrated in FIG. 5. FIG. 5 is a diagram illustrating a hardware configuration of the computer 100.

The computer 100 illustrated in FIG. 5 includes a processor 101, a memory 102, a storage device 103, a portable storage medium drive device 104, a communication interface 105, and an input/output interface 106, and these devices are connected to a bus 107 to transmit and receive data reciprocally.

The processor 101 may be, for example, a single processor, a multiprocessor, or a multi-core processor. The processor 101 performs various types of processing (for example, processing of generating the pixel data of each pixel described above) by executing a program such as an operating system (OS) or an application.

The memory 102 includes a random access memory (RAM) and a read only memory (ROM). A part of the program or the like executed by the processor 101 is temporarily stored in the RAM. In addition, the RAM is also used as a working storage area of the processor 101. The ROM stores the program executed by the processor 101 and various types of data necessary for executing the program.

The storage device 103 stores data, and examples of the device include a hard disk drive (HDD) and a solid state drive (SSD).

The portable storage medium drive device 104 drives a portable storage medium 104a, accesses the content stored therein, and reads and writes data. Examples of the portable storage medium 104a include a memory device, a flexible disk, an optical disk, and a magneto-optical disk. Other examples of the portable storage medium 104a include a compact disc read only memory (CD-ROM), a digital versatile disc (DVD), a Blu-ray Disc, a universal serial bus (USB) memory, and an SD memory card.

The communication interface 105 is connected to a network in a wired or wireless manner and communicates with an external device connected to the network.

The input/output interface 106 is connected to an external device and input/outputs data to/from the external device. Examples of the external device connected to the input/output interface 106 include the laser light source device 10, the microscope body 20, and the PC 40, and an input device and an output device may further be connected thereto. The input device is a keyboard, a mouse, a joystick, a touch panel, or the like, and the output device is a liquid crystal display or the like.

In such a computer 100, the program executed by the processor 101 and various types of data necessary for executing the program may be stored not only in the memory 102 but also in the storage device 103 or the portable storage medium 104a. In addition, the program executed by the processor 101 and various types of data necessary for executing the program may be stored in the storage device 103 or the portable storage medium 104a via the communication interface 105 from an external device connected to a network.

In addition, the computer 100 is not limited to one illustrated in FIG. 5. The number of some components illustrated in FIG. 5 may be two or more. Alternatively, some of the components illustrated in FIG. 5 may be omitted.

In addition, the computer 100 may also include hardware such as a microprocessor, a DSP, an application specific integrated circuit (ASIC), a programmable logic device (PLD), and a field-programmable gate array (FPGA). For example, the processor 101 may be implemented with at least one of the aforementioned hardware.

Although the embodiments of the invention have been described above, the invention is not limited to the above-described embodiments, and various improvements and modifications can be made without departing from the gist of the invention.

What is claimed is:

1. A scanning microscope that samples light from a sample irradiated with pulsed light and converts the light into data for each pixel, wherein
a sampling time per pixel is substantially an integer multiple of a pulse period of the pulsed light, and
a sampling start timing of each pixel is synchronized with a pixel synchronization signal.

2. The scanning microscope according to claim 1, wherein
the sampling time per pixel is an integer multiple of a period including an error of 2 ns or shorter with respect to the pulse period.

3. A scanning microscope comprising:
a laser light source that emits pulsed light;
a scanner that two-dimensionally scans the pulsed light on a sample;
a photodetector that detects light from the sample; and
a processor that generates pixel data of each of pixels forming an image of the sample based on an output signal from the photodetector and a pixel synchronization signal synchronized with a scanning position of the scanner, sets a sampling time per pixel to be substantially an integer multiple of a pulse period of the pulsed light, and synchronizes a sampling start timing of each pixel with the pixel synchronization signal.

4. The scanning microscope according to claim 3, wherein
the processor generates the pixel data by accumulating or averaging a plurality of signals A/D-converted based on a sampling clock in the sampling time per pixel, and
a period of the sampling clock is shorter than the pulse period of the pulsed light.

5. The scanning microscope according to claim 4, wherein
a period of the sampling clock is a multiple of the pulse period of the pulsed light.

6. The scanning microscope according to claim 3, wherein
the photodetector includes a photoelectric conversion element, and
the processor generates the pixel data by performing A/D conversion on a result obtained by integrating output signals of the photoelectric conversion element by the photodetector over a sampling time per pixel.

7. The scanning microscope according to claim 3, wherein
the photodetector includes a photoelectric conversion element, and
the photoelectric conversion element is a photo multiplier tube (PMT) or a multi-pixel photon counter (MPPC).

8. The scanning microscope according to claim 3, wherein
the sampling time per pixel is equal to or shorter than a period of the pixel synchronization signal.

9. The scanning microscope according to claim 3, wherein
the sampling time per pixel is a time exceeding a period of the pixel synchronization signal, and
the processor performs parallel processing in which processing of a subsequent pixel is started during processing of a preceding pixel.

10. The scanning microscope according to claim 3, wherein
the sampling time per pixel is an integer multiple of a period including an error of 2 ns or shorter with respect to the pulse period.

11. A method for processing data for causing a computer to execute processing of sampling light from a sample irradiated with pulsed light and converting the light into data for each pixel, wherein
a sampling time per pixel is substantially an integer multiple of a pulse period of the pulsed light, and
a sampling start timing of each pixel is synchronized with a pixel synchronization signal.

12. A computer-readable storage medium storing a program for causing a computer to execute processing of sampling light from a sample irradiated with pulsed light and converting the light into data for each pixel, wherein
a sampling time per pixel is substantially an integer multiple of a pulse period of the pulsed light, and
a sampling start timing of each pixel is synchronized with a pixel synchronization signal.
